(19) United States
(12) Patent Application Publication
(10) Pub. No.: US 2025/0322131 A1
(43) Pub. Date: Oct. 16, 2025

(54) LOAD ADAPTIVE NOISE TOLERANCE TESTING OF CIRCUIT DESIGN

(71) Applicant: INTERNATIONAL BUSINESS MACHINES CORPORATION, Armonk, NY (US)

(72) Inventors: Sanjay UPRETI, Lexington, KY (US); Michael Henry SITKO, Jericho, VT (US); Steven Joseph KURTZ, Austin, TX (US); Joseph Simon MOLLEN, Rochester, MN (US)

(21) Appl. No.: 18/632,420

(22) Filed: Apr. 11, 2024

(51) Int. Cl. G06F 30/333; G06F 119/02; G06F 119/10

(52) U.S. Cl. CPC G06F 30/333; G06F 2119/02; G06F 2119/10

(57) ABSTRACT

A load adaptive process is provided for noise impact on function testing of circuit design logic cells. The process includes obtaining multiple noise tolerance data curves for different potential capacitive loads on a logic cell. The process includes performing noise impact on function testing of an instance of the logic cell within the circuit design. The performing includes selecting, based on a capacitive load of the logic cell instance of the circuit design, a noise tolerance data curve of the multiple curves, and determining whether the logic cell instance fails noise impact on function testing based on comparing a noise pulse at the logic cell instance to the selected noise tolerance data curve. Further, the process includes initiating, based on the logic cell instance of the circuit design failing the noise impact on function testing, one or more actions to facilitate addressing the failing of the logic cell instance.

### BACKGROUND

The present disclosure relates, in one or more aspects, to facilitating circuit design processing within a computing environment, and more particularly, to noise tolerance verification testing of one or more logic cell instances of a circuit design.

Electronic design automation (EDA) tools utilize computer-aided design to facilitate developing complex electronic systems such as integrated circuits, including very large scale integrated circuits, microprocessors, integrated circuit chips, etc. Electronic design automation tools are used in circuit design simulation, design and verification. The tools allow developers to predict circuit behavior, assemble circuit elements, and anticipate performance of the resultant circuit design prior to fabrication of the circuit.

In one aspect, electronic design automation tools facilitate analysis and verification of a circuit design, or physical design. Physical verification helps ensure that the final integrated circuit operates correctly and meets specifications.

### SUMMARY

Certain shortcomings of the prior art are overcome, and additional advantages are provided herein through the provision of a computer-implemented method of facilitating circuit design processing within a computing environment. The computer-implemented method includes obtaining multiple noise tolerance data curves for different potential capacitive loads on a logic cell of a circuit design. In addition, the computer-implemented method includes performing noise impact on function testing of an instance of the logic cell of the circuit design. The performing includes selecting, based on a capacitive load on the logic cell instance of the circuit design, a noise tolerance data curve of the multiple noise tolerance data curves, and determining whether the logic cell instance fails noise impact on function testing based on comparing a noise pulse at the logic cell instance during the noise impact on function testing to the selected noise tolerance data curve. In addition, the computer-implemented method includes initiating, based on the logic cell instance of the circuit design failing the noise impact on function testing, one or more actions to facilitate addressing the failing of the logic cell instance during the noise impact on function testing.

In another aspect, a computer program product is provided for facilitating circuit design processing within a computing environment. The computer program product includes a set of one or more computer readable storage media, and program instructions, collectively stored in the set of one or more computer readable storage media, for causing at least one processor set to perform operations, where the operations include obtaining multiple noise tolerance data curves for different potential capacitive loads on a logic cell of a circuit design, and performing noise impact on function testing of an instance of the logic cell within the circuit design. The performing includes selecting, based on a capacitive load of the logic cell instance of the circuit design, a noise tolerance data curve of the multiple noise tolerance data curves, and determining whether the logic cell instance fails noise impact on function testing based on comparing a noise pulse at the logic cell instance during the noise impact on function testing to the selected noise tolerance data curve. Further, the operations include initiating, based on the logic cell instance of the logic circuit design failing the noise impact on function testing, one or more actions to facilitate addressing the failing of the logic cell instance during the noise impact on function testing.

In a further aspect, a computer system is provided for facilitating circuit design processing within a computer environment. The computer system includes at least one processor set, a set of one or more computer readable storage media, and program instructions, collectively stored in the set of one or more computer readable storage media, for causing the at least one processor set to perform computer operations. The computer operations include obtaining multiple noise tolerance data curves for different potential capacitive loads on a logic cell of a circuit design, and performing noise impact on function testing of an instance of a logic cell within the circuit design. The performing includes selecting, based on a capacitive load on the logic cell instance of the circuit design, a noise tolerance data curve of the multiple noise tolerance data curves, and determining whether the logic cell instance fails noise impact on function testing based on comparing a noise pulse of the logic cell instance during the noise impact on function testing to the selected noise tolerance data curve. Further, the operations include initiating, based on the logic cell instance of the circuit design failing the noise impact on function testing, one or more actions to facilitate addressing the failing of the logic cell instance during the noise impact on function testing.

Computer-implemented methods, computer program products, and computer systems relating to one or more aspects are described and claimed herein. Each of the embodiments of the computer-implemented methods can be embodiments of each computer program product and/or computer system and vice-versa. Further, each of the embodiments is separable and optional from one another. Moreover, embodiments can be combined with one another. Each of the embodiments of the computer-implemented method can be combinable with aspects and/or embodiments of each computer program product and/or computer system, and vice-versa. Further, services relating to one or more aspects are also described and claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to include and/or use one or more aspects of the present disclosure;

FIGS. 2A-2C depict one or more embodiments of a computer program product with an adaptive noise tolerance module, in accordance with one or more aspects of the present disclosure;

FIGS. 3A-3B depict one embodiment of an adaptive noise tolerance process, in accordance with one or more aspects of the present disclosure;

FIG. 4 illustrates one example of a logic cell instance of a circuit design, and characterizing an associated noise tolerance data curve based on capacitive load on the logic cell instance, in accordance with one or more aspects of the present disclosure;

FIG. 5 graphically illustrates multiple noise tolerance data curves for different potential capacitive loads on a logic cell instance of a circuit design, in accordance with one or more aspects of the present disclosure;

FIG. 6 depicts one embodiment of a process of characterizing a noise tolerance data set for a logic cell of a circuit design, in accordance with one or more aspects of the present disclosure;

FIG. 7 depicts one embodiment of a process of performing noise impact on function testing of a logic cell instance of a circuit design using a noise tolerance data set, in accordance with one or more aspects of the present disclosure;

FIG. 8 is a flow diagram of a design process used in semiconductor design, manufacture, and test, in accordance with one or more aspects of the present disclosure;

FIG. 9 depicts a further example of integrated circuit fabrication, including generating physical design data, in accordance with one or more aspects of the present disclosure; and

FIG. 10 shows an exemplary high level electronic design automation (EDA) tool flow, through which aspects of the present disclosure can be implemented.

### DETAILED DESCRIPTION

Provided herein, in one or more aspects, is a computer-implemented method of facilitating circuit design processing within a computing environment. The computer-implemented method includes obtaining multiple noise tolerance data curves (i.e., noise rejection curves) for different potential capacitive loads on a logic cell of a circuit design. In addition, the computer-implemented method includes performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on comparing a noise pulse at the logic cell instance during the noise impact on function testing to the selected noise tolerance data curve. In addition, the computer-implemented method includes initiating, based on the logic cell instance of the circuit design failing the noise impact on function testing, one or more actions to facilitate addressing the failing of the logic cell instance during the noise impact on function testing. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process.

In embodiments, the different potential capacitive loads for a logic cell include multiple fixed capacitive loads for the logic cell. Facilitating circuit design processing within a computing environment, in accordance with one or more aspects, can include selecting the different potential capacitive loads for the logic cell in one of a variety of ways. In one approach, multiple fixed capacitive loads for the logic cell are defined for the logic cell, that is, for multiple, or all, instances of the logic cell of the circuit design. This approach of using the same fixed capacitive loads for multiple, or all logic, cells can reduce processing otherwise required to obtain the multiple noise tolerance data curves for different potential capacitive loads across multiple instances of the logic cell within the circuit design.

In embodiments, the different potential capacitive loads for the logic cell are based on historical capacitive loads on one or more instances of the logic cell within one or more circuit designs. Facilitating circuit design processing within a computing environment, in accordance with one or more aspects, can include selecting the different potential capacitive loads for the logic cell in a variety of ways. In one approach, the different potential capacitive loads for the logic cell can be based on historical capacitive loads on one or more instances of the logic cell within one or more circuit designs, which can facilitate obtaining multiple noise tolerance data curves for instances of the logic cell across the circuit design based on historically derived capacitive loads on the instances.

In embodiments, the different potential capacitive loads for the logic cell are selected to achieve spaced apart noise tolerance data curves between a noise tolerance data curve for a selected minimum capacitive load condition for the logic cell and a noise tolerance data curve for a selected maximum capacitive load condition for the logic cell of the circuit design. Facilitating circuit design processing within a computing environment, in accordance with one or more aspects, can include selecting the different potential capacitive loads for the logic cell in one of a variety of ways. In one approach, the different potential capacitive loads for the logic cell are selected to achieve spaced apart noise tolerance data curves between a noise tolerance data curve for a selected minimum capacitive load condition and a noise tolerance data curve for a selected maximum capacitive load condition, which facilitates good spaced coverage of the span between the noise tolerance data curves for the minimum and maximum load conditions, and thus good data curve coverage for a variety of capacitive loads on the logic cell.

In embodiments, at least one noise tolerance data curve of the multiple noise tolerance data curves is for a given capacitive load on the logic cell, and is an interpolated data curve between characterized noise data tolerance data curves with specified capacitive loads on the logic cell, where the given capacitive load is between the specified capacitive loads. Circuit design processing within a computing environment is facilitated by ascertaining the given capacitive load on an instantiated logic cell, and interpolating a noise tolerance data curve between characterized noise tolerance data curves with specified capacitive loads on the logic cell, where the given capacitive load is between the specified capacitive loads. In this manner, obtaining useful noise tolerance data curves is facilitated.

In embodiments, the performing includes determining the capacitive load on the logic cell instance as a sink load capacitance on an output pin of the logic cell instance. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load.

In embodiments, selecting the noise tolerance data curve of the multiple noise tolerance data curves based on the capacitive load on the logic cell includes selecting the noise tolerance data curve based on an assumed capacitive load closest to and below the determined sink load capacitance on the output pin on the logic cell instance. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In embodiments, the selecting includes generating a noise tolerance data curve for the capacitive load on the logic cell instance, where the generating includes generating by interpolation a further noise tolerance data curve for the capacitive load on the logic cell instance with reference to one or more noise tolerance data curves for one or more capacitive loads closest to the capacitive load of the multiple noise tolerance data curves. In one or more embodiments, the further noise tolerance data curve is the selected noise tolerance data curve for use in determining whether the logic cell instance of the circuit design passes noise impact on function testing. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

In embodiments, the obtaining includes referencing a cell library file for the logic cell during the noise impact on function testing on the logic cell instance to select the noise tolerance data curve from the multiple noise tolerance data curves. Advantageously, the multiple noise tolerance data curves can be pre-characterized and stored in the cell library file for the logic cell for use during noise impact on function testing for one or more logic cell instances, and in particular, to select a noise tolerance data curve based on the capacitive load on the output pin of the sink cell instance for use during the noise impact on function testing.

In another aspect, a computer program product is provided for facilitating circuit design processing within a computing environment. The computer program product includes a set of one or more computer readable storage media, and program instructions, collectively stored in the set of one or more computer readable storage media, for causing at least one processor set to perform operations including obtaining multiple noise tolerance data curves for different potential capacitive loads on a logic cell of a circuit design, and performing noise impact on function testing of an instance of the logic cell within the circuit design. The performing includes selecting, based on a capacitive load of the logic cell instance of the circuit design, a noise tolerance data curve of the multiple noise tolerance data curves, and determining whether the logic cell instance fails noise impact on function testing based on comparing a noise pulse at the logic cell instance during the noise impact on function testing to the selected noise tolerance data curve. Further, the operations include initiating, based on the logic cell instance of the logic circuit design failing the noise impact on function testing, one or more actions to facilitate addressing the failing of the logic cell instance during the noise impact on function testing. Advantageously, the computer program product facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process.

In embodiments of the computer program product, the different potential capacitive loads for a logic cell include multiple fixed capacitive loads for the logic cell. Facilitating circuit design processing within a computing environment, in accordance with one or more aspects, can include selecting the different potential capacitive loads for the logic cell in one of a variety of ways. In one approach, multiple fixed capacitive loads for the logic cell are defined for the logic cell, that is, for multiple, or all, instances of the logic cell of the circuit design. This approach of using the fixed capacitive loads for multiple, or all, logic cells can reduce processing otherwise required to obtain the multiple noise tolerance data curves for different potential capacitive loads across the multiple instances of the logic cell within the circuit.

In embodiments of the computer program product, the different potential capacitive loads for the logic cell are based on historical capacitive loads on one or more instances of the logic cell within one or more circuit designs. Facilitating circuit design processing within a computing environment, in accordance with one or more aspects, can include selecting the different potential capacitive loads for the logic cell in a variety of ways. In one approach, the different potential capacitive loads for the logic cell can be based on historical capacitive loads on one or more instances of the logic cell within one or more circuit designs, which can facilitate obtaining multiple noise tolerance data curves for instances of the logic cell across the circuit design based on historically derived capacitive loads on the instances.

In embodiments of the computer program product, the different potential capacitive loads for the logic cell are selected to achieve spaced apart noise tolerance data curves between a noise tolerance data curve for a selected minimum capacitive load condition for the logic cell and a noise tolerance data curve for a selected maximum capacitive load condition for the logic cell of the circuit design. Facilitating circuit design processing within a computing environment, in accordance with one or more aspects, can include selecting the different potential capacitive loads for the logic cell in one of a variety of ways. In one approach, the different potential capacitive loads for the logic cell are selected to achieve spaced apart noise tolerance data curves between a noise tolerance data curve for a selected minimum capacitive load condition and a noise tolerance data curve for a selected maximum capacitive load condition, which facilitates good spaced coverage of the span between the noise tolerance data curves for the minimum and maximum load conditions, and thus good data curve coverage for a variety of capacitive loads on the logic cell.

In embodiments of the computer program product, at least one noise tolerance data curve of the multiple noise tolerance data curves is for a given capacitive load on the logic cell, and is an interpolated data curve between characterized noise data tolerance data curves with specified capacitive loads on the logic cell, where the given capacitive load is between the specified capacitive loads. Circuit design processing within a computing environment is facilitated by selecting or ascertaining a given capacitive load on a logic cell, and interpolating a noise tolerance data curve between characterized noise tolerance data curves with specified capacitive loads on the logic cell, where the given capacitive load is between the specified capacitive loads. In this manner, obtaining useful noise tolerance data curves is facilitated.

In embodiments of the computer program product, the performing includes determining the capacitive load on the output cell instance as a sink load capacitance on an output pin of the logic cell instance, and selecting the noise tolerance data curve of the multiple noise tolerance data curves based on the capacitive load on a logic cell includes selecting the noise tolerance data curve based on an assumed capacitive load closest to and below the determined sink load capacitance on the output pin of the logic cell instance. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In embodiments of the computer program product, the performing includes determining the capacitive load on the logic cell instance as a sink load capacitance on an output pin of the logic cell instance, and the selecting includes generating a noise tolerance data curve for the capacitive load on the logic cell instance. The generating includes generating by interpolation a further noise tolerance data curve for the capacitive load on the logic cell instance with reference to one or more noise tolerance data curves for one or more capacitive loads closest to the capacitive load of the multiple noise tolerance data curves. In one or more embodiments, the further noise tolerance data curve is the selected noise tolerance data curve for use in determining whether the logic cell instance of the circuit design passes noise impact on function testing. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

In a further aspect, a computer system is provided for facilitating circuit design processing within a computer environment. The computer system includes at least one processor set, a set of one or more computer readable storage media, and program instructions, collectively stored in the set of one or more computer readable storage media, for causing the at least one processor set to perform computer operations. The computer operations include obtaining multiple noise tolerance data curves for different potential capacitive loads on a logic cell of a circuit design, and performing noise impact on function testing of an instance of the logic cell within the circuit design. The performing includes selecting, based on a capacitive load on a logic cell instance of the circuit design, a noise tolerance data curve of the multiple noise tolerance data curves, and determining whether the logic cell instance fails noise impact on function testing based on comparing a noise pulse of the logic cell instance during the noise impact on function testing to the selected noise tolerance data curve. Further, the operations include initiating, based on the logic cell instance of the circuit design failing the noise impact on function testing, one or more actions to facilitate addressing the failing of the logic cell instance during the noise impact on function testing. Advantageously, the computer system facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process.

In embodiments of the computer system, the performing includes determining the capacitive load on the logic cell instance as a sink load capacitance on an output pin of the logic cell instance. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load.

In embodiments of the computer system, selecting the noise tolerance data curve of the multiple noise tolerance data curves based on the capacitive load on the logic cell includes selecting the noise tolerance data curve based on an assumed capacitive load closest to and below the determined sink load capacitance on the output pin on the logic cell instance. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In embodiments of the computer system, the selecting includes generating a noise tolerance data curve for the capacitive load on the logic cell instance, where the generating includes generating by interpolation a further noise tolerance data curve for the capacitive load on the logic cell instance with reference to one or more noise tolerance data curves for one or more capacitive loads closest to the capacitive load of the multiple noise tolerance data curves. In one or more embodiments, the further noise tolerance data curve is the selected noise tolerance data curve for use in determining whether the logic cell instance of the circuit design passes noise impact on function testing. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell include multiple fixed capacitive loads for the logic cell. Further, the performing includes determining the capacitive load on the instance as a sink load capacitance on an output pin of the logic cell instance, and selecting the noise tolerance data curve of the multiple noise tolerance data curves based on the capacitive load of the cell includes selecting the noise tolerance data curve based on an assumed capacitive load closest to and below the determined sink load capacitance on the output pin of the logic cell instance. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Facilitating circuit design processing within a computing environment, in accordance with one or more aspects, can include selecting the different potential capacitive loads for the logic cell in one of a variety of ways. In one approach, multiple fixed capacitive loads for the logic cell are defined for the logic cell, that is, for multiple, or all, instances of the logic cell of the circuit design. This approach of using the same fixed capacitive loads for multiple, or all, logic cells can reduce processing otherwise required to obtain the multiple noise tolerance data curves for different potential capacitive loads across the multiple instances of the logic cell within the circuit design. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell are based on historical capacitive loads on one or more instances of the logic cell within one or more circuit designs. Further, the performing includes determining the capacitive load on the instance as a sink load capacitance on an output pin of the logic cell instance, and selecting the noise tolerance data curve of the multiple noise tolerance data curves based on the capacitive load of the cell includes selecting the noise tolerance data curve based on an assumed capacitive load closest to and below the determined sink load capacitance on the output pin of the logic cell instance. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Facilitating circuit design processing within a computing environment, in accordance with one or more aspects, can include selecting the different potential capacitive loads for the logic cell in a variety of ways. In one approach, the different potential capacitive loads for the logic cell can be based on historical capacitive loads on one or more instances of the logic cell within one or more circuit designs, which can facilitate obtaining multiple noise tolerance data curves for instances of the logic cell across the circuit design based on historically derived capacitive loads on the instances. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell are selected to achieve spaced apart noise tolerance data curves between a noise tolerance data curve for a selected minimum capacitive load condition for the logic cell and a noise tolerance data curve for a selected maximum capacitive load condition for the logic cell of the circuit design. Further, the performing includes determining the capacitive load on the instance as a sink load capacitance on an output pin of the logic cell instance, and selecting the noise tolerance data curve of the multiple noise tolerance data curves based on the capacitive load of the cell includes selecting the noise tolerance data curve based on an assumed capacitive load closest to and below the determined sink load capacitance on the output pin of the logic cell instance. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Facilitating circuit design processing within a computing environment, in accordance with one or more aspects, can include selecting the different potential capacitive loads for the logic cell in one of a variety of ways. In one approach, the different potential capacitive loads for the logic cell are selected to achieve spaced apart noise tolerance data curves between a noise tolerance data curve for a selected minimum capacitive load condition and a noise tolerance data curve for a selected maximum capacitive load condition, which facilitates good spaced coverage of the span between the noise tolerance data curves for the minimum and maximum load conditions, and thus good data curve coverage for a variety of capacitive loads on the logic cell. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. At least one noise tolerance data curve of the multiple noise tolerance data curves is for a given capacitive load on the logic cell, and is an interpolated data curve between characterized noise tolerance data curves with specified capacitive loads on the logic cell, where the given capacitive load is between the specified capacitive loads. Further, the performing includes determining the capacitive load on the instance as a sink load capacitance on an output pin of the logic cell instance, and selecting the noise tolerance data curve of the multiple noise tolerance data curves based on the capacitive load of the cell includes selecting the noise tolerance data curve based on an assumed capacitive load closest to and below the determined sink load capacitance on the output pin of the logic cell instance. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Circuit design processing within a computing environment is facilitated by selecting or ascertaining a given capacitive load on a logic cell, and interpolating a noise tolerance data curve between characterized noise tolerance data curves with specified capacitive loads on the logic cell, where the given capacitive load is between the specified capacitive loads. In this manner, obtaining useful noise tolerance data curves is facilitated. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By selecting the noise tolerance data curve based on an assumed capacitive load closest to and below the determined sink capacitive load on the output pin of the logic cell instance, the noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell include multiple fixed capacitive loads for the logic cell. Further, the performing includes determining the capacitive load on the instance as a sink load capacitance on an output pin of the logic cell instance, and the selecting includes generating a noise tolerance data curve for the capacitive load on the logic cell instance. The generating includes generating by interpolation a further noise tolerance data curve for the capacitive load on the logic cell instance with reference to one or more noise tolerance data curves for one or more capacitive loads closest to the capacitive load of the multiple noise tolerance data curves, where the further noise tolerance data curve is the selected noise tolerance data curve used in determining whether the logic cell instance of the circuit design passes noise impact on function testing. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Facilitating circuit design processing within a computing environment, in accordance with one or more aspects, can include selecting the different potential capacitive loads for the logic cell in one of a variety of ways. In one approach, multiple fixed capacitive loads for the logic cell are defined for the logic cell, that is, for multiple, or all, instances of the logic cell of the circuit design. This approach of using the same fixed capacitive loads for multiple, or all, logic cells can reduce processing otherwise required to obtain the multiple noise tolerance data curves for different potential capacitive loads across the multiple instances of the logic cell within the circuit design. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell are based on historical capacitive loads on one or more instances of the logic cell within one or more circuit designs. Further, the performing includes determining the capacitive load on the instance as a sink load capacitance on an output pin of the logic cell instance, and the selecting includes generating a noise tolerance data curve for the capacitive load on the logic cell instance. The generating includes generating by interpolation a further noise tolerance data curve for the capacitive load on the logic cell instance with reference to one or more noise tolerance data curves for one or more capacitive loads closest to the capacitive load of the multiple noise tolerance data curves, where the further noise tolerance data curve is the selected noise tolerance data curve used in determining whether the logic cell instance of the circuit design passes noise impact on function testing. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Facilitating circuit design processing within a computing environment, in accordance with one or more aspects, can include selecting the different potential capacitive loads for the logic cell in a variety of ways. In one approach, the different potential capacitive loads for the logic cell can be based on historical capacitive loads on one or more instances of the logic cell within one or more circuit designs, which can facilitate obtaining multiple noise tolerance data curves for instances of the logic cell across the circuit design based on historically derived capacitive loads on the instances. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell are selected to achieve spaced apart noise tolerance data curves between a noise tolerance data curve for a selected minimum capacitive load condition for the logic cell and a noise tolerance data curve for a selected maximum capacitive load condition for the logic cell of the circuit design. Further, the performing includes determining the capacitive load on the instance as a sink load capacitance on an output pin of the logic cell instance, and the selecting includes generating a noise tolerance data curve for the capacitive load on the logic cell instance. The generating includes generating by interpolation a further noise tolerance data curve for the capacitive load on the logic cell instance with reference to one or more noise tolerance data curves for one or more capacitive loads closest to the capacitive load of the multiple noise tolerance data curves, where the further noise tolerance data curve is the selected noise tolerance data curve used in determining whether the logic cell instance of the circuit design passes noise impact on function testing. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Facilitating circuit design processing within a computing environment, in accordance with one or more aspects, can include selecting the different potential capacitive loads for the logic cell in one of a variety of ways. In one approach, the different potential capacitive loads for the logic cell are selected to achieve spaced apart noise tolerance data curves between a noise tolerance data curve for a selected minimum capacitive load condition and a noise tolerance data curve for a selected maximum capacitive load condition, which facilitates good spaced coverage of the span between the noise tolerance data curves for the minimum and maximum load conditions, and thus good data curve coverage for a variety of capacitive loads on the logic cell. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

In another aspect, a computer-implemented method, computer program product, and computer system are provided that implement a process, which includes obtaining multiple noise tolerance data curves for different potential capacitive loads on a logic cell of a circuit design, and performing noise impact on function testing of an instance of the logic cell of the circuit design. The performing includes selecting, based on a capacitive load of the logic cell instance of the circuit design, a noise tolerance data curve of the multiple noise tolerance data curves, and determining whether the logic cell instance fails noise impact on function testing based on a comparison of a noise pulse at the logic cell instance during the noise impact on function testing to the selected noise tolerance data curve. In addition, the process includes initiating, based on the logic cell instance of the circuit design failing the noise impact on function testing, one or more actions to facilitate addressing the failing of the logic cell instance during the noise impact on function testing. The different potential capacitive loads for the logic cell at least one noise tolerance data curve of the multiple noise tolerance data curves is for a given capacitive load on the logic cell, and is an interpolated data curve between characterized noise tolerance data curves with specified capacitive loads on the logic cell, where the given capacitive load is between the specified capacitive loads. Further, the performing includes determining the capacitive load on the instance as a sink load capacitance on an output pin of the logic cell instance, and the selecting includes generating a noise tolerance data curve for the capacitive load on the logic cell instance. The generating includes generating by interpolation a further noise tolerance data curve for the capacitive load on the logic cell instance with reference to one or more noise tolerance data curves for one or more capacitive loads closest to the capacitive load of the multiple noise tolerance data curves, where the further noise tolerance data curve is the selected noise tolerance data curve used in determining whether the logic cell instance of the circuit design passes noise impact on function testing. Advantageously, the computer-implemented method facilitates circuit design processing within a computing environment, and in particular, facilitates noise tolerance verification testing of one or more logic cell instances of a circuit design by reducing false noise violations. By providing multiple noise tolerance data curves for different potential capacitive loads on a logic cell of the circuit design, and selecting, based on a capacitive load of a logic cell instance of the circuit design, a particular noise tolerance data curve of the multiple noise tolerance data curves, noise impact on function testing of the logic cell instance is adapted or more closely tailored to the particular load capacitance on the logic cell instance, which saves resources by reducing the number of false noise violations during the testing, and improves overall productivity of the circuit design process. Circuit design processing within a computing environment is facilitated by selecting or ascertaining a given capacitive load on a logic cell, and interpolating a noise tolerance data curve between characterized noise tolerance data curves with specified capacitive loads on the logic cell, where the given capacitive load is between the specified capacitive loads. In this manner, obtaining useful noise tolerance data curves is facilitated. Advantageously, load adaptive noise tolerance testing based on the sink load capacitance on an output pin of the logic cell instance reduces, or minimizes, false noise violations from the testing, which improves productivity of the circuit design process. A significant amount of resources can be saved by minimizing the work of identifying and/or addressing false noise violations. Advantageously, the selected noise tolerance data curve is adapted to the driven load, thereby avoiding certain inherent pessimism in existing noise impact on function testing using a constant minimum load. By interpolating the further noise tolerance data curve for the capacitive load on the logic cell instance, the selected noise tolerance data curve is better adapted to the sink load capacitance on the logic cell instance, which reduces, or minimizes, false noise violations during noise impact on function testing.

Aspects of the present disclosure and certain features, advantages, and details thereof, are explained more fully below with reference to the non-limiting example(s) illustrated in the accompanying drawings. Descriptions of well-known systems, devices, processing techniques, tools, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific circuits, code, designs, architectures, protocols, layouts, schematics, systems, or tools only as examples, and not by way of limitation. Furthermore, the illustrative embodiments are described in certain instances using particular logic circuits, software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in hardware or software or a combination thereof.

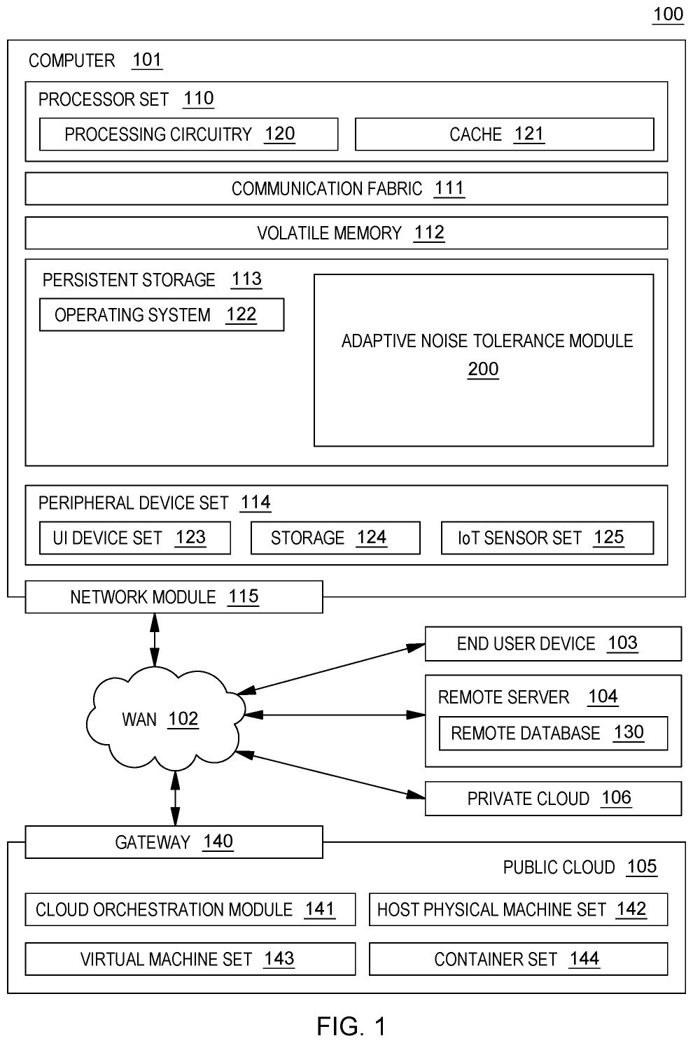

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and adaptive noise tolerance module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform adaptive noise tolerance processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as adaptive noise tolerance module 200. In addition to module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions (or logic) for performing the inventive methods may be stored (or located) in module 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in module 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

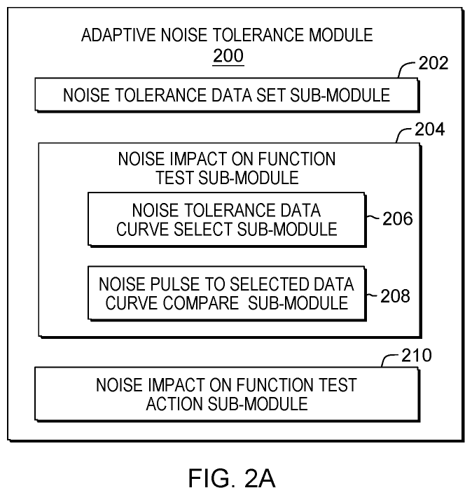

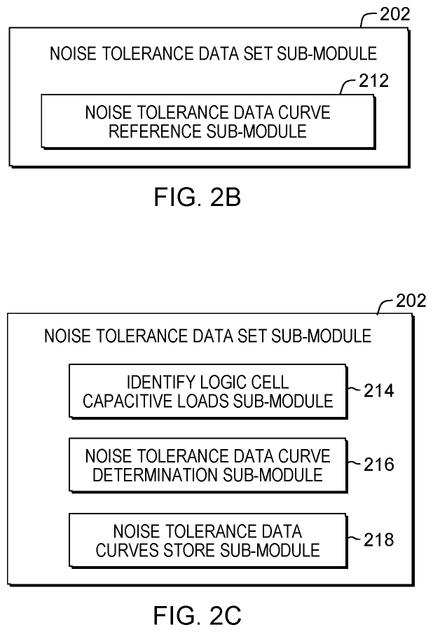

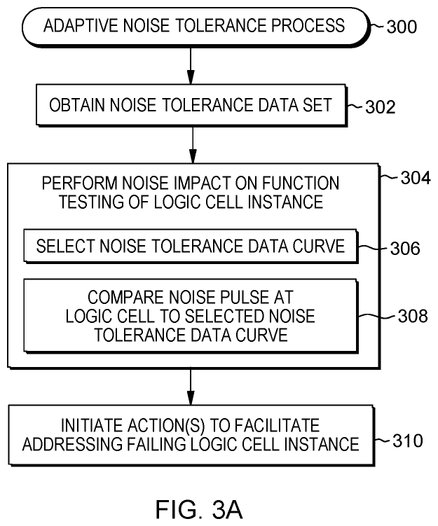

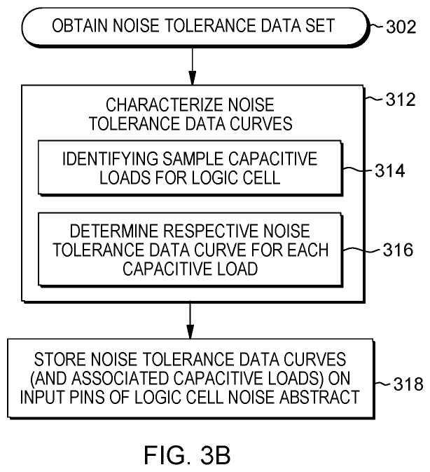

By way of example, one or more embodiments of an adaptive noise tolerance module and process are described initially with reference to FIGS. 2A-3B. FIGS. 2A-2C depict one or more embodiments of adaptive noise tolerance module 200 that includes code or instructions to perform adaptive noise tolerance processing, in accordance with one or more aspects of the present disclosure, and FIGS. 3A-3C depicts one embodiment of an adaptive noise tolerance process, in accordance with one or more aspects of the present disclosure.

Referring to FIGS. 1-2C, adaptive noise tolerance module 200 includes, in one example, various sub-modules used to perform processing, in accordance with one or more aspects of the present disclosure. The sub-modules are, e.g., computer-readable program code (e.g., instructions) and computer-readable media (e.g., persistent storge (e.g., persistent storage 113, such as a disk) and/or a cache (e.g., cache 121), as examples). The computer-readable media can be part of a computer program product and can be executed by and/or using one or more computers, such as computer(s) 101; one or more processor sets 110 (FIG. 1); processors, such as one or more processors of processor set 110; and/or processing circuitry, such as processing circuitry of processor set 110, etc.

As noted, FIGS. 2A-2C depict one or more embodiments of an adaptive noise tolerance module 200 which, in one or more embodiments, includes, or facilitates, adaptive noise tolerance processing in accordance with one or more aspects of the present disclosure. In the embodiment(s) of FIGS. 2A-2C, example sub-modules of adaptive noise tolerance module 200 include a noise tolerance data set sub-module 202 to facilitate obtaining multiple noise tolerance data curves (i.e., noise rejection curves) for different potential capacitive loads on a logic cell of a circuit design. In addition, in one or more embodiments, adaptive noise tolerance module 200 includes a noise impact on function test sub-module 204 to perform noise impact on function testing of an instance of the logic cell of the circuit design. Noise impact on function test sub-module 204 includes, in one or more embodiments, a noise tolerance data curve select sub-module 206 to select, based on a capacitive load of the logic cell instance of the circuit design, a noise tolerance data curve of the multiple noise tolerance data curves. In addition, noise impact on function test sub-module 204 includes, in one or more embodiments, a noise pulse to selected data curve compare sub-module 208 to determine whether the logic cell instance fails noise impact on function testing based on comparing a noise pulse at the logic cell instance during the noise impact on function testing to the selected noise tolerance data curve. Note that as used herein, “noise impact on function testing” refers to circuit design analysis to determine whether the size of the noise pulse in, for instance, a selected wire (which is created when one or more neighboring wires switch) is above some tolerance threshold (that is, the selected noise tolerance data curve (or noise rejection curve)). If the threshold is exceeded, then it is possible that the correct logical state of the wire can be disturbed or corrupted, resulting in a computational error sometimes referred to as a “noise glitch”. The threshold can be defined and measured at an input of a logic gate, and thus discussed herein is the intelligent selection of noise tolerance data curves or noise rejection curves on the logical gates. Adaptive noise tolerance module 200 further includes, in one or more embodiments, a noise impact on function test action sub-module 210 to initiate or generate, based on the logic cell instance of the circuit design failing noise impact on function testing, one or more actions to facilitate addressing the failing physical design behavior during the noise impact on function testing. In one or more embodiments, the one or more actions can include one or more automated processes to facilitate addressing or correcting the physical design failing the noise impact on function test. For instance, in one or more embodiments, one or more characteristics of the logic cell instance or the wiring of the circuit or the logic gate acting as the driver, or another aspect of the circuit design can be adjusted based on the noise violation, and the process repeated to perform noise impact on function testing of the adjusted logic cell instance/circuit design.

FIG. 2B depicts one embodiment of noise tolerance data set sub-module 202, which can include, in one or more aspects, a noise tolerance data curve reference sub-module 212 to reference a pre-characterized noise tolerance data set or table for a logic cell of a circuit design, where the noise tolerance data set includes multiple noise tolerance data curves, including noise tolerance data curves for different potential capacitive loads on the logic cell, such as described herein.

In FIG. 2C, another embodiment of noise tolerance data set sub-module 202 is illustrated. In this embodiment, noise tolerance data set sub-module 202 includes sub-modules to facilitate characterizing and storing the noise tolerance data curves of the noise tolerance data set. In one or more embodiments, noise tolerance data set sub-module 202 includes an identify logic cell capacitive loads sub-module 214 to identify different potential capacitive loads on the logic cell for which corresponding noise tolerance data curves are to be generated, and a noise tolerance data curve determination sub-module 216 for determining, or calculating, the respective noise tolerance data curve for each identified logic cell capacitive load, such as a sink load capacitance on an output pin of the logic cell. In addition, in one or more embodiments, noise tolerance data set sub-module 202 of FIG. 2C includes a noise tolerance data curves store sub-module 218 to store the determined noise tolerance data curves for the different identified potential capacitive loads of the logic cell. In one or more embodiments, the noise tolerance data set can be stored in a cell library file for the logic cell, such as a cell library file for an input pin of the logic cell for reference during the noise impact on function testing of the logic cell instance, such as described herein.

Note that although various sub-modules are described herein, adaptive noise tolerance module processing, such as disclosed, can use, or include, additional, fewer, and/or different sub-modules. A particular sub-module can include additional code, including code of other sub-modules, or less code. Further, additional and/or fewer sub-modules can be used. Many variations are possible.

Advantageously, in one or more aspects, improved circuit design processing within the computing environment is provided. In one or more embodiments, circuit design validation is facilitated by adapting noise tolerance of a logic cell instance based on its load capacitance for noise impact on function validation testing. In one or more aspects, multiple load-based noise tolerance data curves (i.e., noise rejection curves) are used to reduce pessimism during noise analysis without impact on runtime by generating appropriately pre-characterized data curves based on potential output capacitance loads, such as a capacitance load on a sink gate output of the logic cell. In real macros, the time savings in generating fewer noise impact on function violations is significant, and in general, the noise slack distribution shifts to the right, that is, provides more positive slack, when using adaptive noise tolerance processing such as described herein.

In one or more embodiments, the adaptive noise tolerance module is used, in accordance with one or more aspects of the present disclosure, to perform adaptive noise tolerance processing. FIGS. 3A-3B depict one example of an adaptive noise tolerance process 300, such as disclosed herein. The process is executed, in one or more embodiments, by a computer (e.g., computer 101 (FIG. 1)), and/or one or more processor sets, such as a processor or processing circuitry (e.g., of processor set 110 of FIG. 1). In one example, code or instructions implementing the process, are part of a module, such as adaptive noise tolerance module 200. In other examples, the code can be included in one or more other modules and/or one or more other sub-modules of the one or more other modules. Various options are available.

As illustrated in FIG. 3A, in one example, adaptive noise tolerance process 300 executing on one or more computers (e.g., computer 101 of FIG. 1), one or more processor sets (e.g., processor set 110 of FIG. 1, such as a processor of processing circuitry of the processor set) obtains a noise tolerance data set for a logic cell of a circuit design 302. In one or more embodiments, obtaining the noise tolerance data set can include referencing a pre-characterized noise tolerance data set contained in a cell library file of the logic cell during, or in association with, noise impact on function testing of the logic cell instance to select a noise tolerance data curve from the multiple noise tolerance data curves of the data set. FIG. 3B illustrates another embodiment where obtaining the noise tolerance data set 302 can include characterizing multiple noise tolerance data curves 312 by, for instance, identifying sample capacitive loads for the logic cell 314 and determining respective noise tolerance data curves for each identified capacitive load 316. In one or more embodiments, the different capacitive loads on the logic cell can include multiple fixed sink gate capacitive loads on the logic cell. In one or more other embodiments, the different potential capacitive loads on the logic cell can be based on historical capacitive loads on instances of the logic cell, such as instances on one or more other circuit designs, or the same circuit design. In one or more other embodiments, the different potential capacitive loads on the logic cell can be selected to achieve spaced apart noise tolerance data curves between a noise data curve for a selected or specified minimum capacitive load condition on the logic cell, and a noise tolerance data curve for a selected or specified maximum capacitive load condition on the logic cell of the circuit design. In one or more embodiments, the obtaining noise tolerance data set process of FIG. 3B also includes storing the noise tolerance data curves, and associated capacitive loads, such as on the input pins of the logic cell noise abstract 318.

As illustrated in FIG. 3A, in one or more embodiments, the noise adaptive tolerance process 300 further includes performing noise impact on function testing of a logic cell instance of the circuit design 304. In embodiments, the performing noise impact on function testing includes selecting a noise tolerance data curve 306 from the multiple noise tolerance data curves of the noise tolerance data set for the logic cell, and comparing a noise pulse at the logic cell instance to the selected noise tolerance data curve 308 to determine whether the logic cell instance fails or passes noise impact on function testing based on the comparison. In embodiments, adaptive noise tolerance process 300 further includes, based on a failing of the logic cell instance of the circuit design, initiating, or generating, one or more actions to facilitate addressing the noise violation 310, such as to adjust one or more characteristics of the logic cell instance and/or the circuit design to facilitate the logic cell passing the noise validation processing of the circuit design.

As noted initially, electronic design automation (EDA) tools utilize computer-aided design to facilitate developing complex electronic systems, such as integrated circuits, including very large scale integrated circuits, microprocessors, and integrated circuit chips, etc. Electronic design automation tools are used in circuit design simulation, design and verification. The tools allow developers to predict circuit behavior, assemble circuit elements, and anticipate performance of the resultant circuit design prior to verification of the circuit. Electronic design automation tools also facilitate, in one or more aspects, analysis and verification of a circuit design, or physical design. Physical verification helps ensure that the final integrated circuit operates correctly and meets specifications.

In very large scale integrated circuit (VLSI) designs or chips, the standard library cells (e.g., gates) are the building blocks of more complex random logic macros (RLMs) that are used for a specific function in the circuit design. These cells are characterized using circuit simulators for their behavior with respect to timing, power, and noise (also referred to as signal integrity) metrics. Noise characterization involves simulating the behavior of a cell as noise propagates from each of its inputs all the way to the output of the cell. A simple and efficient way of characterizing the cell for noise is by generating a noise rejection curve (NRC), also referred to herein as a noise tolerance data curve, for each input of the cell or gate, and reporting how much noise is on each output of the cell. This process also computes the output impedance (resistance) values so that a reasonable driver model can be used when the cell drives a net into a sink gate in a random logic macro (RLMs) during noise impact on function (NIOF) testing or analysis. The electronic design automation tool file that contains the noise rejection curve and the output noise, as well as the output impedance value, is known as the noise abstract (NA). Conventionally, the noise abstract is a static noise abstract, since it assumes a fixed, well defined load being driven by the cell, and a fixed standard average noise pulse propagating from the input to the output.

The above-noted approach to determining the noise abstract for a cell is one way to characterize the cell (or gate), and generate the noise abstract for a custom macro. A weakness, however, is that the approach uses an overly pessimistic output pin load capacitance value which affects the noise tolerances at the inputs of the cell due to the assumed fixed load. In general, the smallest acceptable load for a standard cell is used in practice to account for a worst-case scenario. In many cases, this overly pessimistic output noise can produce false failures during noise impact on function testing of the cell. Disclosed herein are computer-implemented methods, computer program products, and computer systems which address this issue by providing more realistic noise abstracts for cells, such as, for standard library cells of a circuit design.

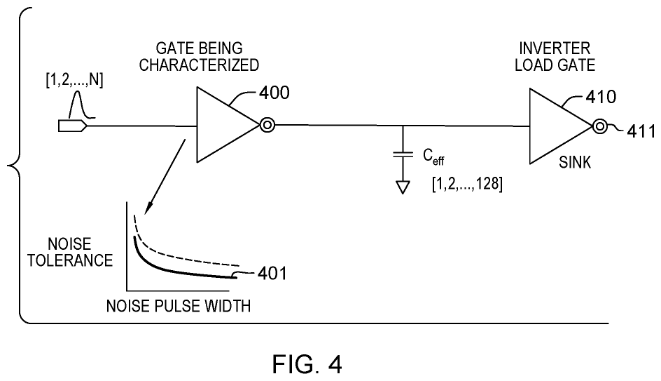

For noise impact on function testing or validation, one of the components of a noise rule is the noise rejection curve (NRC), which represents how much noise can an input tolerate for a given pulse width, before the output causes a noise violation. An example of this is depicted in FIG. 4, where a cell 400 being characterized, such as an inverter, has an effective capacitance C_{eff} based, in part, on a length of the output wire, and the load, which in the example of FIG. 4 is an inverter load gate 410 with a noise evaluation point 411 being at an output of inverter load gate 410, in one example. As noted, conventionally, the standard library cells or gates are characterized at a constant minimum capacitive load, such as at a minimum effective capacitance C_{eff} of 1 fF, as an example. However, in practical circuit designs, most cells (or gates) drive a much higher load, thus making the resultant noise rejection curve (NRC) 401 used in noise impact on function testing today relatively (and in some cases excessively) pessimistic, resulting in excessive numbers of noise violations during testing.

Disclosed herein are computer-implemented methods, computer program products, and computer systems, which overcome the above-noted shortcomings of traditional noise abstracts for standard library cells characterized at a constant minimum capacitive load by providing load adaptive noise tolerance testing of a circuit design. In one or more aspects, load adaptive noise rules are generated by generating noise tolerance data curves (or noise rejection curves) that cover more completely the range of possible capacitive loads a given cell of the circuit design can drive. During the gate level sign off (GLSO) process for noise impact on function (NIOF) testing, a linear interpolation can be performed, in one approach, to predict or select the desired noise tolerance data curve for the actual capacitive load a cell encounters in the circuit design. The load adaptive noise tolerance testing disclosed here, in one or more aspects, turns the conventional static noise tolerance testing approach into a quasi-dynamic approach, and proves significant advantages over the default pessimistic noise rules currently in use. The load adaptive noise tolerance testing disclosed herein not only reduces or minimizes, false noise violations, but also saves significant amount of resources by minimizing the work of fixing noise violations that were false violations. Overall, it improves productivity of the circuit design process.

Most of the industry uses Complementary Current Source Model (CCS-Model) based rules for standard cell libraries that are part of the dot-lib specifications. While these CCS rules provide a better driver model, they do not have a mechanism to specify noise rejection curves, or noise tolerances. Conventionally, the circuit design industry relies on the CCS dot-lib rules for noise impact on function testing, and as such, stays with the most pessimistic capacitive load analysis approach. Disclosed herein are approaches to scaling noise tolerance data curves (or noise rejection curves) to adapt or select a curve for a particular driven capacitive load. In doing so, some of the typical pessimism inherent in conventional noise impact on function testing is avoided, reducing the number of false noise violation indications during the testing.

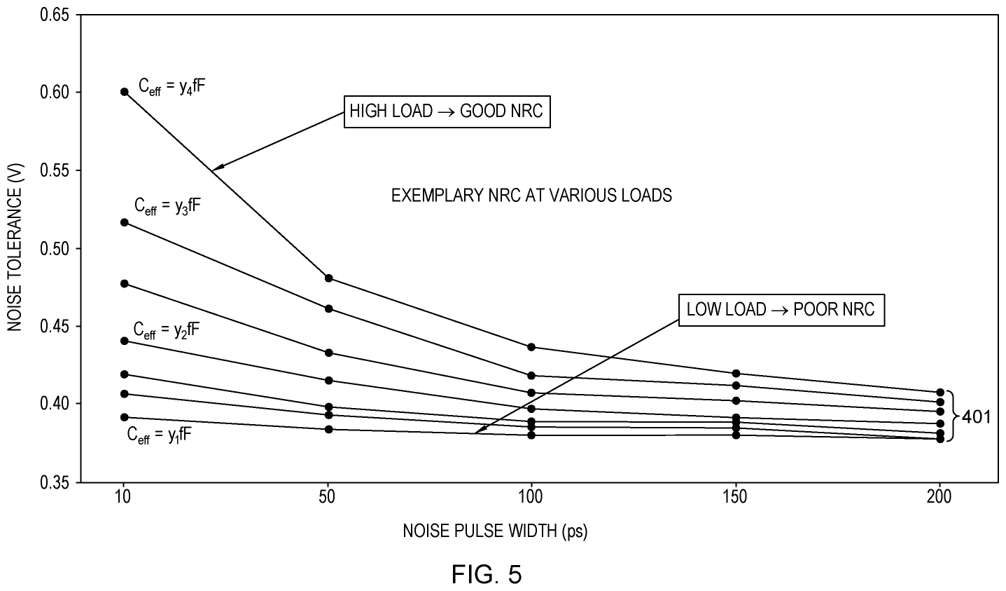

In one or more aspects, a noise tolerance data set for a logic cell of a circuit design is obtained by characterizing, for instance, a logic cell at two or more different capacitive loads and storing the resultant noise tolerance data curves as part of one or more noise abstracts for the standard library cell. As illustrated in FIGS. 4 & 5, the noise abstract at an input of a logic cell can have multiple noise tolerance data curves 401 (i.e., noise rejection curves) each characterized for a different capacitive load condition on the cell. An expanded example of the graph in FIG. 4 is presented in FIG. 5 where noise tolerance in voltage is plotted against noise pulse width in picoseconds for different effective capacitive loads (e.g., y₁ fF . . . y₄ fF) at the output of the cell. By way of example, the multiple noise rejection curves or noise tolerance data curves include multiple curves at different effective capacitance loads from a low load, effect capacitance of y₁ fF to a high load, effect capacitance of y₄ fF. In this case, the amount of noise tolerance or noise slack gained by considering a noise tolerance data curve other than the minimum noise tolerance data curve is approximately 0.2 volts, from 0.4 to 0.6 volts in the graph, which depends on the effective capacitance load. As known, noise tolerance refers to how much noise a logic cell can tolerate before there is a noise violation. The greater the noise pulse width, the lower the noise tolerance. In this manner, the digital logic cells (or gates) are characterized with different noise tolerance levels depending on the capacitive load of the gate's output pin, where the capacitive load for each output gate is determined independently to provide a more effective coverage of the expected range of actual circuit loads using, for instance, a minimum number of noise tolerance data curves. In this manner, load adaptive noise tolerance testing is facilitated to improve the accuracy of the functional noise analysis, while reducing pessimism in the tool, resulting in an improved circuit design and faster design closure and acceptance.

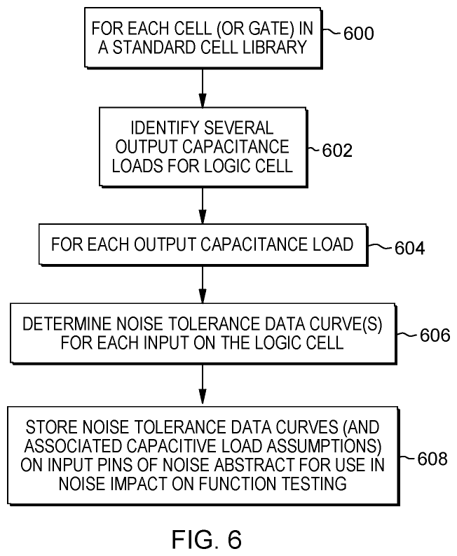

FIG. 6 depicts one embodiment of a process of characterizing a noise tolerance data set for a logic cell of a circuit design, in accordance with one or more aspects of present disclosure. As illustrated, for each logic cell (or gate) in a standard cell library 600, several output capacitance loads for the logic cell are identified 602. A variety of approaches can be used for identifying representative capacitance loads for the logic cell. As an example embodiment, the process can include determining the noise tolerance data curve with a minimum effective capacitive load (for instance, save 100ps amplitude (i.e., the amplitude at 100ps pulse width)), and determine the noise tolerance data curve for a maximum capacitive load condition (for instance, save 100ps amplitude). The process identifies a number of desired data curves, and identifies (in one embodiment) ideal amplitudes for each data curve at the 100ps point, by way of example. For instance, in one or more embodiments, x noise tolerance data curves (or noise rejection curves) can be selected whose 100ps amplitude measurements equally divide the range between minimum and maximum amplitudes observed. For instance, in one embodiment, x can be a relatively low number such as 2-5, in one embodiment. For each desired data curve amplitude, the process can include increasing the effective capacitive load from a previous data curve load (e.g., the minimum data curve load) until the 100ps amplitude of the new data curve is close to the desired amplitude.

As illustrated in FIG. 6, for each output capacitance load 604, the noise tolerance data curve is determined for each input on the logic cell 606, and the resultant noise tolerance data curves (i.e., noise rejection curves), and the associated load assumptions, are stored on the input pins of the noise abstract for use in noise impact on function testing 608.

Those skilled in the art will note that there are many approaches to how the process of FIG. 6 can be optimized to identify, for instance, a best minimum and/or maximum effective capacitive load to sweep, the number of curves stored, etc. For instance, in one approach, the process can include looking for instances of logic cells in a large sample of random logic macros (RLMs) of a circuit design, and plotting the histograms of the load distributions of each cell type. Using the plot, the first and third quartiles can be selected as two load points apart from the minimum load the cell drives. Thus, three capacitive load samples are obtained, that is, the minimum effective load, the Q1 load, and the Q3 load, by way of example. Noise tolerance data curves can then be generated for each of these three load conditions. During the gate level sign-off (GLSO) process of the noise impact on function (NIOF) testing, the processing can determine the actual load a specific instance of a logic cell is driving, and then select the noise tolerance data curve from the multiple noise tolerance data curves that corresponds to the largest characterized capacitive load that is below the actual capacitive load for that logic cell instance. In this manner, the amount of pessimism in the noise tolerance analysis is reduced, with the testing results being much closer to the actual noise rejection of the circuit, as compared with using the worst-case capacitive load approach. Since from process to process, the load distribution does not change significantly, it is also possible to adaptively identify the capacitive load for a given node based on the random logic macro (RLM) routing at the previous node, in one example.

In another exemplary embodiment, the theoretical largest and smallest capacitive loads a logic cell can drive are determined, along with the best and worst case noise tolerance data curves based on those loads. With the noise tolerance data curves identified for the maximum and minimum capacitive loads, then x (such as x being between 2 and 5), additional data curves are generated between the minimum and maximum curves, with the generating curves being equidistant in one example. Processing can search for the capacitive load using the binary search method that will correspond to these curves. In this manner, there is ability to provide closely spaced noise tolerance data curves with the desired accuracy. Based on analysis, for instance, at 5 nm nodes, it has been found that 5 such curves provide sufficient accuracy to significantly reduce false noise violations. An advantage of this process is that is entirely adaptive, and does not depend on previously generated load data, thus allowing the entire process to be automated.

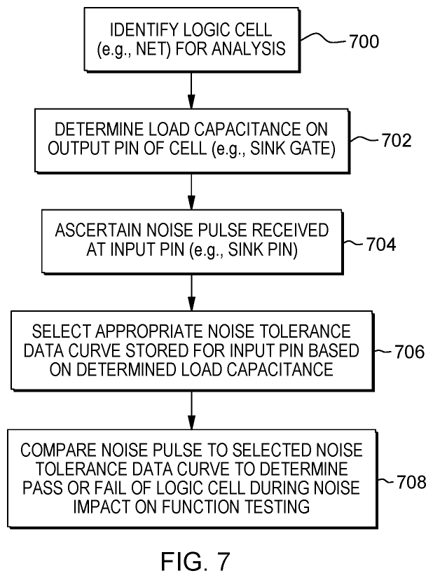

FIG. 7 depicts one embodiment of a process for performing, in part, noise impact on function testing of a logic cell instance of a circuit design using a noise tolerance data set, in accordance with one or more aspects of present disclosure. The processing includes identifying a logic cell (for instance, net) for analysis 700, and determining load capacitance on an output pin of the cell 702, such as determining or calculating load capacitance of an output pin of a sink gate. The process includes ascertaining or calculating a noise pulse received at or hitting an input pin (or sink pin) of the logic cell 704, and selecting an appropriate noise tolerance data curve stored for the input pin based on the determined load capacitance 706. Selecting the appropriate noise tolerance data curve or noise rejection curve, can be accomplished in a number of ways. For instance, the best noise tolerance data curve (that is, with the highest associated load capacitance that is lower than the actual logic cell load capacitance) can be selected. In another approach, the noise tolerance data curves that are adjacent above and below the observed or determined logic cell load can be selected, and interpolation used to build the noise tolerance data curve for the observed load on the logic cell instance.

Other variations are possible. For instance, the different potential capacitance loads on the logic cell can include multiple fixed sink gate capacitive loads for the logic cell. In another embodiment, the different potential capacitive loads on the logic cell can be based on historical capacitive loads on instances of the logic cell within one or more circuit designs, such as one or more other circuit designs. In another embodiment, the different potential capacitive loads on the logic cell can be selected to achieve spaced apart noise tolerance data curves between a noise tolerance data curve for a selected or determined minimum capacitive load condition on the logic cell, and a noise tolerance data curve for a selected or determined maximum capacitive load condition on the logic cell of the circuit design. In a further embodiment, at least one noise tolerance data curve of the multiple noise tolerance data curves for a logic cell of the circuit design can be for a given capacitive load on the logic cell, and a data curve can be interpolated between pre-characterized noise tolerance data curves with specified load capacitance on the logic cell, with the given capacitive load being between the specified capacitive loads.

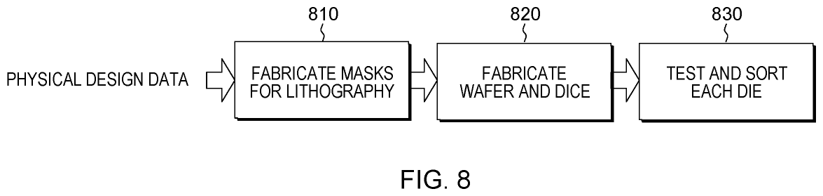

In one or more embodiments, a further step includes fabricating a physical integrated circuit, such as described herein, in accordance with the circuit design. One non-limiting specific example that accomplishes this is described herein in connection with FIGS. 8-10. For example, the circuit design, or circuit design structure, is provided to fabrication equipment to facilitate fabrication of a physical integrated circuit in accordance with the design structure.

In one or more embodiments, a layout is prepared based on the analysis. In one or more embodiments, the layout is instantiated as a design structure. In one or more embodiments, a physical integrated circuit is fabricated in accordance with the design structure.

As noted, in one or more embodiments, the layout is instantiated as a design structure. A physical integrated circuit is then fabricated in accordance with the design structure. Refer also to discussion for FIGS. 8-10. FIG. 8 is a flow diagram of a design process used in semiconductor design, manufacture, and/or test. Once the physical design data is obtained, based, in part, on the design processes described herein, an integrated circuit designed in accordance therewith can be fabricated according to known processes that are generally described with reference to FIG. 8. Generally, a wafer with multiple copies of the final design is fabricated and cut (i.e., diced) such that each die is one copy of the integrated circuit. At block 810, the processes include fabricating masks for lithography based on the finalized physical layout. At block 820, fabricating the wafer includes using the masks to perform photolithography and etching. Once the wafer is diced, testing and sorting each die is performed at 830 to filter out any faulty die. Furthermore, referring to FIGS. 8-10, in one or more embodiments the at least one processor is operative to generate a design structure for the integrated circuit design in accordance with the circuit design, such as a VLSI design, and in at least some embodiments, the at least one processor is further operative to control integrated circuit manufacturing equipment to fabricate a physical integrated circuit in accordance with the design structure. Thus, the layout can be instantiated as a design structure, and the design structure can be provided to fabrication equipment to facilitate fabrication of a physical integrated circuit in accordance with the design structure. The physical integrated circuit will be improved (for example, because of proper capacitance extraction) compared to circuits designed using prior art techniques, at least under conditions where there is the same CPU time budget for the design process. To achieve similar improvements with prior-art techniques, even if possible, would require expenditure of more CPU time as compared to embodiments of the invention.

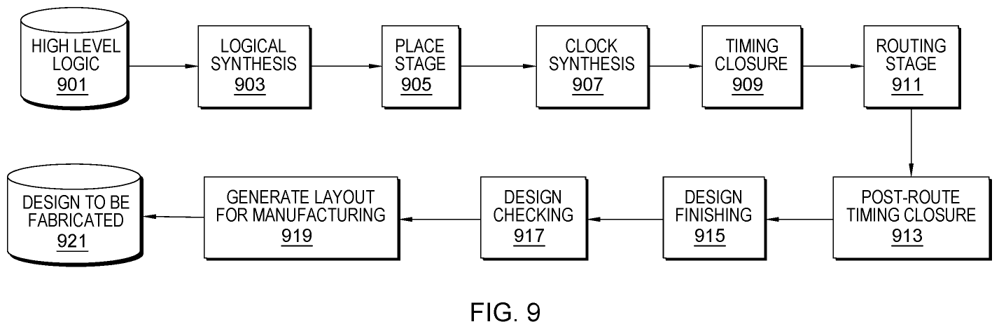

FIG. 9 depicts an example high-level Electronic Design Automation (EDA) tool flow, which is responsible for creating an optimized microprocessor (or other IC) design to be manufactured. A designer can start with a high-level logic description 901 of the circuit (e.g. VHDL or Verilog). The logic synthesis tool 903 compiles the logic and optimizes it without any sense of its physical representation, and with estimated timing information. Placement tool 905 takes the logical description and places each component, looking to minimize congestion in each area of the design. The clock synthesis tool 907 optimizes the clock tree network by cloning/balancing/buffering the latches or registers. The timing closure step 909 performs a number of optimizations on the design, including buffering, wire tuning, and circuit repowering; its goal is to produce a design which is routable, without timing violations, and without excess power consumption. Routing stage 911 takes the placed/optimized design and determines how to create wires to connect the components, without causing manufacturing violations. Post-route timing closure 913 performs another set of optimizations to resolve any violations that are remaining after the routing. Design finishing 915 then adds extra metal shapes to the netlist, to conform with manufacturing requirements. Checking steps 917 analyze whether the design is violating any requirements such as manufacturing, timing, power, electromigration or noise. When the design is clean, the final step 919 is to generate a layout for the design, representing all the shapes to be fabricated in the design to be fabricated 921.

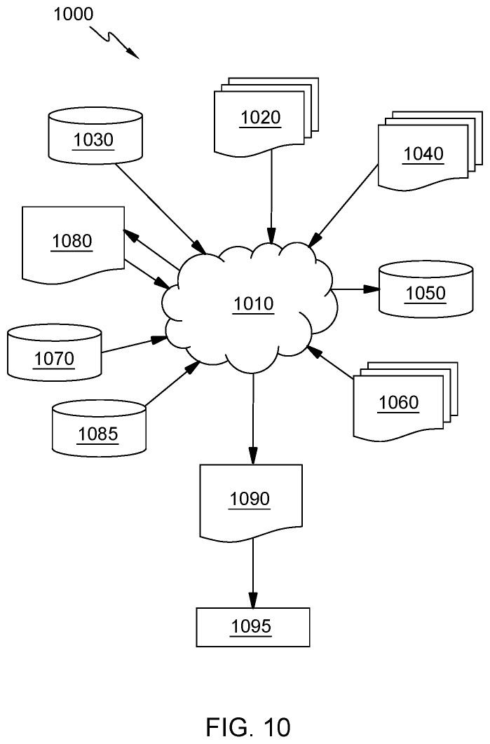

One or more embodiments integrate the timing analysis techniques herein with semiconductor integrated circuit design simulation, test, layout, and/or manufacture. In this regard, FIG. 10 shows a block diagram of an exemplary design flow 1000 used for example, in semiconductor IC logic design, simulation, test, layout, and manufacture. Design flow 1000 includes processes, machines and/or mechanisms for processing design structures or devices to generate logically or otherwise functionally equivalent representations of design structures and/or devices, such as those that can be analyzed using timing analysis or the like. The design structures processed and/or generated by design flow 1000 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g., E-V writers), computers, or equipment for simulating design structures, any apparatus used in the manufacturing or test process, or any machines for programming functionality equivalent representations of the design structures into any medium (e.g., a machine for programming a programmable gate array).

Design flow 1000 may vary depending on the type of representation being designed. For example, a design flow 1000 for building an application specific IC (ASIC) may differ from a design flow 1000 for designing a standard component or from a design flow 1000 for instantiating the design into a programmable array, for example a programmable gate array (PGA) or a field programmable gate array (FPGA).

FIG. 10 illustrates multiple such design structures 1020 that is preferably processed by a design process 1010. Design structure 1020 may be a logical simulation design structure generated and processed by design process 1010 to produce a logically equivalent functional representation of a hardware device. Design structure 1020 may also or alternatively comprise data and/or program instructions that when processed by design process 1010, generate a functional representation of the physical structure of a hardware device. Whether representing functional and/or structural design features, design structure 1020 may be generated using electronic computer-aided design (ECAD), such as implemented by a core developer/designer. When encoded on a gate array or storage medium of the loke, design structure 1020 may be accessed and processed by one or more hardware and/or software modules within design process 1010 to simulate or otherwise functionally represent an electronic component, circuit, electronic or logic module, apparatus, device, or system. As such, design structure 1020 may comprise files or other data structures including human and/or machine-readable source code, compiled structures, and computer executable code structure that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages, such as Verilog and VHDL, and/or higher level design languages, such as C or C++.

Design process 1010 preferably employs and incorporates hardware and/or software modules for synthesizing, translating, or otherwise processing a design/simulation functional equivalent of components, circuits, devices, or logic structures to generate a Netlist 1080, which may contain design structures such as design structure 1020. Netlist 1080 may comprise, for example, compiled or otherwise processed data structures representing a list of wires, discrete components, logic gates, control circuits, I/O devices, modules, etc., that describes the connections to other elements and circuits in an integrated circuit design. Netlist 1080 may be recorded on a machine-readable data storage medium or programmed into a programmable gate array, a compact flash, or other flash memory. Additionally, or in the alternative, the medium may be a system or cache memory, buffer space, or other suitable memory.

Design process 1010 may include hardware and software modules for processing a variety of input data structure system, including Netlist 1080. Such data structure types may reside, for example, within library elements 1030 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1040, characterization data 1050, verification data 1060, design rules 1070, and test data files 1085, which may include input test patterns, output test results, and other testing information. Design process 1010 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1010 without deviating from the scope and spirit of the invention. Design process 1010 may also include modules for performing standard circuit design processes such as timing analysis, verification, design rule checking, place and route operations, etc. Improved placement can be performed as described herein.

Design process 1010 employs and incorporates logic and physical design tools such as HDL compilers and simulation model build tools to process design structure 1020 together with some or all of the depicted supporting data structures along with any additional mechanical design or data (if applicable), to generate a second design structure 1090. Design structure 1090 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 1020, design structure 1090 preferably comprises one or 10 more files, data structures, or other computer-encoded data or instructions that reside on data storage media and that when processed by an ECAD system generate a logically or otherwise functionally equivalent form of one or more IC designs or the like. In one embodiment, design structure 1090 may comprise a compiled, executable HDL simulation model that functionally simulates the devices to be analyzed.

Design structure 1090 may also employ a data format used for the exchange of layout data of integrated circuits and/or symbolic data format (e.g. information stored in a GDSII (GDS2), GL1, OASIS, map files, or any other suitable format for storing such design data structures). Design structure 1090 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., .lib files). Design structure 1090 may then proceed to a stage 1095 where, for example, design structure 1090: proceeds to tape-out, is released to manufacturing, is released to a mask house, is sent to another design house, is sent back to the customer, etc.

The computing environments described herein are only examples of computing environments that can be used. One or more aspects of the present disclosure may be used with many types of environments. The computing environments provided herein are only examples. Each computing environment is capable of being configured to include one or more aspects of the present disclosure.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other memory access instructions may be used. Further, other predictors may be used, including, but not limited to, other examples of a counter table and/or a global counter. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating circuit design processing within a computing environment, the computer-implemented method comprising:
obtaining multiple noise tolerance data curves for different potential capacitive loads on a logic cell of a circuit design;
performing noise impact on function testing of an instance of the logic cell within the circuit design, the performing including:
selecting, based on a capacitive load on the logic cell instance of the circuit design, a noise tolerance data curve of the multiple noise tolerance data curves; and
determining whether the logic cell instance fails noise impact on function testing based on comparing a noise pulse at the logic cell instance during the noise impact on function testing to the selected noise tolerance data curve; and
initiating, based on the logic cell instance of the circuit design failing the noise impact on function testing, one or more actions to facilitate addressing the failing of the logic cell instance during the noise impact on function testing.

2. The computer-implemented method of claim 1, wherein the different potential capacitive loads for the logic cell comprise multiple fixed capacitive loads for the logic cell.

3. The computer-implemented method of claim 1, wherein the different potential capacitive loads for the logic cell are based on historical capacitive loads on one or more instances of the logic cell within one or more other circuit designs.

4. The computer-implemented method of claim 1, wherein the different potential capacitive loads for the logic cell are selected to achieve spaced apart noise tolerance data curves between a noise tolerance data curve for a selected minimum capacitive load condition for the logic cell and a noise tolerance data curve for a selected maximum capacitive load condition for the logic cell of the circuit design.

5. The computer-implemented method of claim 1, wherein at least one noise tolerance data curve of the multiple noise tolerance data curves is for a given capacitive load on the logic cell, and is an interpolated data curve between characterized noise tolerance data curves with specified capacitive loads on the logic cell, the given capacitive load being between the specified capacitive loads.

6. The computer-implemented method of claim 1, wherein the performing further includes determining the capacitive load on the logic cell instance as a sink load capacitance on an output pin of the logic cell instance.

7. The computer-implemented method of claim 6, wherein selecting the noise tolerance data curve of the multiple noise tolerance data curves based on the capacitive load on the logic cell comprises selecting the noise tolerance data curve based on an assumed capacitive load closest to and below the determined sink load capacitance on the output pin of the logic cell instance.

8. The computer-implemented method of claim 6, wherein the selecting comprises generating a noise tolerance data curve for the capacitive load on the logic cell instance, the generating including generating by interpolation a further noise tolerance data curve for the capacitive load on the logic cell instance with reference to one or more noise tolerance data curves for one or more capacitive loads closest to the capacitive load of the multiple noise tolerance data curves, wherein the further noise tolerance data curve is the selected noise tolerance data curve for use in determining whether the logic cell instance of the circuit design passes noise impact on function testing.

9. The computer-implemented method of claim 1, wherein the obtaining comprises referencing a cell library file for the logic cell during the noise impact on function testing of the logic cell instance to select the noise tolerance data curve from the multiple noise tolerance data curves.

10. A computer program product for facilitating circuit design processing within a computing environment, the computer program product comprising:
a set of one or more computer readable storage media; and
program instructions, collectively stored in the set of one or more computer readable storage media, for causing at least one processor set to perform computer operations comprising:
obtaining multiple noise tolerance data curves for different potential capacitive loads on a logic cell of a circuit design;
performing noise impact on function testing of an instance of the logic cell within the circuit design, the performing including:
selecting, based on a capacitive load on the logic cell instance of the circuit design, a noise tolerance data curve of the multiple noise tolerance data curves; and
determining whether the logic cell instance fails noise impact on function testing based on comparing a noise pulse at the logic cell instance during the noise impact on function testing to the selected noise tolerance data curve; and
initiating, based on the logic cell instance of the circuit design failing the noise impact on function testing, one or more actions to facilitate addressing the failing of the logic cell instance during the noise impact on function testing.

11. The computer program product of claim 10, wherein the different potential capacitive loads for the logic cell comprise multiple fixed capacitive loads for the logic cell.

12. The computer program product of claim 10, wherein the different potential capacitive loads for the logic cell are based on historical capacitive loads on one or more instances of the logic cell within one or more other circuit designs.

13. The computer program product of claim 10, wherein the different potential capacitive loads for the logic cell are selected to achieve spaced apart noise tolerance data curves between a noise tolerance data curve for a selected minimum capacitive load condition for the logic cell and a noise tolerance data curve for a selected maximum capacitive load condition for the logic cell of the circuit design.

14. The computer program product of claim 10, wherein at least one noise tolerance data curve of the multiple noise tolerance data curves is for a given capacitive load on the logic cell, and is an interpolated data curve between characterized noise tolerance data curves with specified capacitive loads on the logic cell, the given capacitive load being between the specified capacitive loads.

15. The computer program product of claim 10, wherein the performing further includes determining the capacitive load on the logic cell instance as a sink load capacitance on an output pin of the logic cell instance, and the selecting the noise tolerance curve of the multiple noise tolerance curves for the capacitance load on the logic cell comprises selecting the noise tolerance data curve based on an assumed capacitive load closest to and below the determined sink load capacitance on the output pin of the logic cell instance.

16. The computer program product of claim 10, wherein the performing further includes determining the capacitive load on the logic cell instance as a sink load capacitance on an output pin of the logic cell instance, and wherein the selecting includes generating a noise tolerance data curve for the capacitive load on the logic cell instance, the generating including generating by interpolation a further noise tolerance data curve for the capacitive load on the logic cell instance with reference to one or more noise tolerance data curves for one or more capacitive loads closest to the capacitive load of the multiple noise tolerance data curves, wherein the further noise tolerance data curve is the selected noise tolerance data curve for use in determining whether the logic cell instance of the circuit design passes noise impact on function testing.

17. A computer system for facilitating circuit design processing within a computing environment, the computer system comprising:
at least one processor set;
a set of one or more computer readable storage media; and
program instructions, collectively stored in the set of one or more computer readable storage media, for causing the at least one processor set to perform computer operations comprising:
obtaining multiple noise tolerance data curves for different potential capacitive loads on a logic cell of a circuit design;
performing noise impact on function testing of an instance of the logic cell within the circuit design, the performing including:
selecting, based on a capacitive load on the logic cell instance of the circuit design, a noise tolerance data curve of the multiple noise tolerance data curves; and
determining whether the logic cell instance fails noise impact on function testing based on comparing a noise pulse at the logic cell instance during the noise impact on function testing to the selected noise tolerance data curve; and
initiating, based on the logic cell instance of the circuit design failing the noise impact on function testing, one or more actions to facilitate addressing the failing of the logic cell instance during the noise impact on function testing.

18. The computer system of claim 17, wherein the performing further includes determining the capacitive load on the logic cell instance as a sink load capacitance on an output pin of the logic cell instance.

19. The computer system of claim 18, wherein selecting the noise tolerance data curve of the multiple noise tolerance data curves based on the capacitive load on the logic cell comprises selecting the noise tolerance data curve based on an assumed capacitive load closest to and below the determined sink load capacitance on the output pin of the logic cell instance.

20. The computer system of claim 18, wherein the selecting comprises generating a noise tolerance data curve for the capacitive load on the logic cell instance, the generating including generating by interpolation a further noise tolerance data curve for the capacitive load on the logic cell instance with reference to one or more noise tolerance data curves for one or more capacitive loads closest to the capacitive load of the multiple noise tolerance data curves, wherein the further noise tolerance data curve is the selected noise tolerance data curve for use in determining whether the logic cell instance of the circuit design passes noise impact on function testing.
